(19) United States
(12) Patent Application Publication
(10) Pub. No.: US 2026/0094846 A1
(43) Pub. Date: Apr. 2, 2026

(54) ELECTRODE AND ELECTROCHEMICAL CELL

(71) Applicant: CERES INTELLECTUAL PROPERTY COMPANY LIMITED, Sussex (GB)

(72) Inventors: Per HJALMARSSON, Sussex (GB); Chandra MACAULEY, Sussex (GB); Robert LEAH, Sussex (GB)

(21) Appl. No.: 19/110,968

(22) PCT Filed: Sep. 12, 2023
(86) PCT No.: PCT/GB2023/052357

§ 371 Date: Mar. 12, 2025

(30) Foreign Application Priority Data
Sep. 13, 2022 (GB) 2213383.9

(51) Int. Cl. H01M 4/86; C25B 1/04; C25B 1/23; C25B 9/77; C25B 11/032; C25B 11/047; C25B 13/07; H01M 4/88; H01M 4/90; H01M 8/0236; H01M 8/12; H01M 8/126

(52) U.S. Cl. CPC H01M 4/8621; C25B 9/77; C25B 11/032; C25B 11/047; C25B 13/07; H01M 4/8807; H01M 4/9033; H01M 8/0236; H01M 8/126; C25B 1/04; C25B 1/23; H01M 2008/1293

(57) ABSTRACT

An electrochemical cell is disclosed having a porous metal support, a gas transport layer on the porous metal support, and an electrode layer on the gas transport layer. The gas transport layer is electrically conductive and has an open pore structure comprising a pore volume fraction of 20% by volume or higher and wherein the electrode layer has a pore volume fraction lower than the pore volume fraction of the gas transport layer. Also disclosed is a stack of such electrochemical cells and a method of producing such an electrochemical cell.

### FIELD OF THE INVENTION

The present invention relates to electrochemical cells, to stacks of electrochemical cells, and to methods of producing such electrochemical cells.

### BACKGROUND OF THE INVENTION

Electrochemical cells formed of oxide layers (often known as solid oxide cells: SOC) may be used as fuel cells or electrolyser/electrolysis cells.

SOC fuel cell units produce electricity using an electrochemical conversion process that oxidises fuel. SOC cell units can also, or instead, operate as regenerative fuel cells (or reverse fuel cells) units, often known as solid oxide electrolyser fuel cell units, for example to separate hydrogen and oxygen from water, or carbon monoxide and oxygen from carbon dioxide.

SOC units are generally ceramic-based, using an oxygen-ion conducting metal-oxide containing ceramic as an electrolyte. Many ceramic oxygen ion conductors (for instance, doped zirconium oxide or doped cerium oxide) have useful ion conductivities at temperatures in excess of 500° C. (for cerium-oxide based electrolytes) or 650° C. (for zirconium oxide-based ceramics), so SOCs tend to operate at elevated temperatures.

A solid oxide fuel cell (SOFC) generates electrical energy through the electrochemical oxidation of a fuel gas (usually hydrogen-based). In operation, the electrolyte of the SOFC conducts oxygen ions from a cathode to an anode located on opposite sides of the electrolyte. A fuel, for example a fuel derived from the reforming of a hydrocarbon or alcohol, contacts the anode (usually known as the “fuel electrode”) and an oxidant, such as air or an oxygen rich fluid, contacts the cathode (usually known as the “air electrode”).

A solid oxide electrolyser cell (SOEC) may have the same structure as an SOFC but is in practice an SOFC operating in reverse, or in a regenerative mode, to achieve the electrolysis of water and/or carbon dioxide.

Conventional ceramic-supported (e.g. anode-supported) SOCs have low mechanical strength and are vulnerable to fracture. Hence, metal-supported SOCs have recently been developed which have the active fuel cell component layers supported on a metal substrate. In these cells, the ceramic layers can be very thin since they only perform an electrochemical function: that is to say, the ceramic layers are not self-supporting but rather are thin coatings/films laid down on and supported by the metal substrate. Such metal supported SOC stacks are more robust, lower cost, have better thermal properties than ceramic-supported SOCs and can be sealed using conventional metal welding techniques.

Applicant's earlier patent application WO-A-2015/136295 discloses metal-supported SOFCs in which the electrochemically active layers (or active fuel cell component layers) comprise anode, electrolyte and cathode layers respectively deposited (e.g. as thin coatings/films) on, and supported by, a metal support plate (e.g. foil). The metal support plate has a porous region surrounded by a non-porous region with the active layers being deposited upon the porous region so that gases may pass through the pores from one side of the metal support plate to the opposite side to access the active layers coated thereon. The porous region comprises discrete apertures (holes drilled through the metal foil substrate) extending through the support plate, overlying the anode (or cathode, depending on the orientation of the electrochemically active layers). US-A-2007/0072070 discloses an electrochemical cell support structure comprising a conductive base defining a plurality of holes passing through said conductive base; and a microporous cellular substrate disposed on said conductive base. US-A-2013/0124413 discloses a fuel cell incorporating a metallised gas diffusion layer. US-A-2011/0143254 discloses fuel cells, membrane electrode assemblies and fuel cell processes. CN-A-113667998 discloses a reversible SOEC with a porous metal support layer. US-A-2012/021332 discloses a double layer anode in a SOFC.

There is still a need, however, to provide porous metal supported electrochemical cells with improved performance especially at higher current densities for SOFC or SOEC applications.

It is an aim of the present invention to address such a need.

### SUMMARY OF THE INVENTION

The present invention accordingly provides, in a first aspect, an electrochemical cell comprising: a porous metal support, a gas transport layer on the porous metal support, and an electrode layer on the gas transport layer, wherein the gas transport layer is electrically conductive (e.g. in reducing atmosphere) and has an open pore structure comprising a pore volume fraction of 20% by volume or higher and wherein the electrode layer has a pore volume fraction lower than the pore volume fraction of the gas transport layer.

This is advantageous because the gas transport layer usefully provides the functions of improved gas flow within the cell between metal support and electrode, mechanical support to the electrode at the same time as providing electronic conductivity from the metal support to electrode. The gas transport layer, since it is situated between the metal support and the electrode and has a pore volume fraction derived from its microstructure, allows enhanced gas diffusion. Providing the gas transport layer may allow use of lower porosity metal supports without adverse effects on the operation of the SOFC or SOEC. The operation of the SOFC or SOEC may be less prone to being gas transport- or diffusion-limited especially at higher current densities where there may be greater mass flow. This is especially beneficial where lateral diffusion (e.g. diffusion parallel to the metal support between the pores of the metal support) may be rate limiting. Such advantages are particular applicable to SOEC mode because the effects from Knudsen transport makes transport and concentration of gas within the porous layer more restrictive.

The gas transport layer is preferably coated on the porous metal support.

The gas transport layer may not be directly on the surface of porous metal support; there may, for example, be one or more layers (e.g. a barrier layer to reduce corrosion) between the gas transport layer and the surface of the porous metal support.

The gas transport layer may comprise an electrically conductive ceramic material. Suitably, the gas transport layer may comprise a perovskite material. Thus, the gas transport layer may comprise a doped perovskite material, optionally lanthanum strontium chromium manganite (La_{0.75}Sr_{0.25}Cr_{0.5}Mn_{0.5}O₃₋ₓ), doped SrTiO₃, YₓCa₁₋ₓCr_{y}Co_{1-y}O_{3-δ}, Y_{0.8}Ca_{0.2}Cr_{0.8}Co₀₂O₃ (YCCC-SDC), Sr₂Fe_{1.5}Mo_{0.5}O₆MgMoO₆, SrFe_{0.2}Co_{0.4}Mo_{0.4}O₃ (SFCM), PrBaMn₂O₅ (PBMO) and/or mixtures thereof. x may be 0.4 to 0.9

Doped SrTiO₃ may comprise SrTiO₃ doped with one or more dopants selected from Nb, Y, La, Ni, Ca, Fe, Ce, optionally doped SrTiO₃ comprises La_{0.2}Sr_{0.8}Ti_{0.9}Ni_{0.1}O₃ or La_{0.2}Sr_{0.8}Ce_{0.1}Ti_{0.9}Ni_{0.1}O₃ (LSCNT).

Generally, the gas transport layer may have a thickness of 5 μm or higher, optionally 7 μm or higher, optionally 10 μm or higher, optionally 15 μm or higher, optionally 20 μm or higher, optionally 25 μm or higher, optionally 30 μm or higher, optionally 35 μm or higher, optionally 40 μm or higher.

The gas transport layer may have a thickness of 80 μm or lower, optionally 70 μm or lower, optionally 60 μm or lower, optionally 50 μm or lower, optionally 40 μm or lower.

Thus, optionally the gas transport layer may have a thickness in the range 5 μm to 80 μm, optionally 10 μm to 40 μm.

Suitably, the gas transport layer may have a pore volume fraction of 22% or higher, optionally 25% or higher, optionally 30% or higher.

The gas transport layer may have a pore volume fraction of 75% or lower, optionally 70% or lower, optionally 65% or lower.

Thus, the gas transport layer may have a pore volume fraction in the range of 20% to 75%, optionally in the range of 25% to 75%, optionally in the range of 30% to 70%

The pore volume fraction may be determined by a number of methods including 2D SEM images, focused ion beam-scanning electron microscopy (FIB-SEM) tomography, X-ray computed tomography (CT), BET surface area analysis involving gas (e.g. Ar, Kr or N₂) adsorption, and/or Hg intrusion.

Suitably, the gas transport layer may have an average pore size of 200 nm or higher, optionally 300 nm or higher, optionally 400 nm or higher.

The gas transport layer may have an average pore size of 1.5 μm or lower, optionally 1.2 μm or lower, optionally 800 nm or lower, optionally 600 nm or lower.

Thus, the gas transport layer may have an average pore size in the range 200 nm to 1.5 μm, optionally 300 nm to 1.5 μm, optionally 300 nm to 1.2 μm, optionally 300 nm to 1000 nm, optionally 400 nm to 800nm optionally 400 nm to 600nm

The electrode layer may comprise a different material to the gas transport layer.

The electrode layer may comprise doped ceria or doped zirconia.

Suitably, the electrode layer may comprise doped ceria gadolinium oxide (CGO) or yttrium stabilised zirconia.

The electrode layer will usually comprise a source of nickel, optionally nickel oxide. The electrode layer may comprise nickel CGO cermet.

The electrode layer may have a thickness of 0.5 μm or higher, optionally 0.8 μm or higher, optionally 0.9 μm or higher, optionally 1.1 μm or higher, optionally 1.4 μm or higher, optionally 1.8 μm or higher, optionally 2 μm or higher, optionally 2.2 μm or higher, optionally 2.5 μm or higher, optionally 2.8 μm or higher, optionally 3 μm or higher, optionally 5 μm or higher, optionally 10 μm or higher, optionally 15 μm or higher.

The electrode layer may have a thickness of 60 μm or lower, optionally 50 μm or lower, optionally 45 μm or lower, optionally 40 μm or lower, optionally 35 μm or lower, optionally 25 μm or lower.

Thus, the electrode layer may have a thickness in the range 0.5 μm to 60 μm, 3 μm to 60 μm, 5 μm to 50 μm, optionally 15 μm to 25 μm.

It may be advantageous to provide a relatively thin electrode layer. Thus, the electrode layer may have a thickness in the range 0.5 μm to 5 μm, optionally the electrode layer may have a thickness in the range 0.5 μm to 4 μm, optionally the electrode layer may have a thickness in the range 0.5 μm to 3 μm, optionally the electrode layer may have a thickness in the range 0.5 μm to 2 μm, optionally the electrode layer may have a thickness in the range 1 μm to 3 μm, optionally the electrode layer may have a thickness in the range 2 μm to 3 μm.

The ratio of the thicknesses of the gas transport layer to the electrode layer may be 0.5 or higher, optionally 0.7 or higher, optionally 0.9 or higher, optionally 1.1 or higher, optionally 1.5 or higher, optionally 1.75 or higher, optionally 2 or higher, optionally 5 or higher, optionally 7 or higher, optionally 10 or higher, optionally 15 or higher, optionally 20 or higher, optionally 30 or higher, optionally 35 or higher.

The electrode may be a fuel electrode.

The electrochemical cell may further comprise an electrolyte layer on the electrode layer.

The electrolyte (which may be an electrolyte system comprised of multiple layers) may have an intermediate layer (e.g. a further layer of the electrode) between the electrode layer and the electrolyte or the electrode layer may be directly in contact with (i.e. immediately adjacent to) a layer of the electrolyte.

The electrolyte layer may comprise doped ceria, optionally selected from samarium-doped ceria (SDC), gadolinium-doped ceria (GDC), praseodymium doped ceria (PDC), samaria-gadolinia doped ceria (SGDC) and mixtures thereof.

Doped ceria may comprise cerium gadolinium oxide (CGO), which may be a solid solution having the formula, Ce₍₁₋ₓ₎GdₓO_{(2-0.5x-δ)} where 0<x≤0.5.

The electrolyte layer may comprise doped zirconia, optionally selected from scandia stabilised zirconia (ScSZ), yttria stabilised zirconia (YSZ), scandia ceria co-stabilised zirconia (ScCeSZ), ytterbia stabilised zirconia (YbSZ), scandia yttria co-stabilised zirconia (ScYSZ) and mixtures thereof. Doped zirconia may be a solid solution which may be of formula Zr₍₁₋ₓ₎YₓO_{(2-0.5x-δ)} where 0<x≤0.2.

The electrolyte may surround the GTL and electrode layer to reduce or prevent gas escaping laterally through the GTL or electrode layer.

The electrochemical cell may further comprise a second electrode on the electrolyte layer. The second electrode may be an air electrode. The second electrode may comprise one or more layers.

The electrochemical cell may comprise a solid oxide electrochemical cell.

The electrochemical cell may be, or may be in use, a fuel cell, or an electrolyser (also referred to as an electrolysis) cell. In fuel cell mode, a fuel contacts the anode (fuel electrode) and an oxidant, such as air or an oxygen-rich fluid, contacts the cathode (air electrode), so in fuel cell mode operation, the air electrode will be the cathode. A solid oxide electrolyser cell (SOEC) may have the same structure as an SOFC, but is essentially the SOFC operating in reverse, or in a regenerative mode, to achieve the electrolysis of e.g. water and/or carbon dioxide to produce hydrogen gas and/or carbon monoxide and oxygen.

Thus, the electrochemical cell may be, in use, an electrolysis cell.

Alternatively, the electrochemical cell may be, in use, a fuel cell or a reversible fuel cell.

Further alternatives are that the electrochemical cell may be an oxygen separator, or a sensor.

The metal support may comprise a metallic foil (i.e. solid metal) in which openings are provided. That has an advantage that the porosity can be tailored and positioned in specific areas of the substrate.

The porous metal support may comprise steel, preferably stainless steel. Preferably, the porous metal support may comprise a drilled metal support, optionally a laser drilled metal support. The porous metal support may have a barrier layer on the surface thereof to reduce corrosion.

The ratio of functional area of the metal support to the area of pores (e.g. holes drilled) in the metal support may be 20 or higher, optionally 50 or higher, optionally 80 or higher, optionally 100 or higher, optionally 110 or higher, optionally 120 or higher, optionally 130 or higher, optionally 140 or higher, optionally 150 or higher.

The ratio of functional area of the metal support to the area of pores (e.g. holes drilled) in the metal support may be 2500 or lower, optionally 2000 or lower, optionally 1500 or lower, optionally 1000 or lower, optionally 500 or lower, optionally 250 or lower.

Thus, generally, the ratio of functional area of the metal support to the area of pores (e.g. holes drilled) in the metal support may be in the range 20 to 2500.

The hole diameter of pores (optionally holes drilled) in the metal support may optionally be in the range 5 μm to 50 μm, optionally 10 μm to 30 μm.

In some circumstances (e.g. where it is desired to further protect the metal support from corrosion) the porous metal support may comprise a barrier layer on the surface thereof and the gas transport layer may be on the barrier layer.

Electrochemical cells according to the first aspect may be arranged in a stack of electrochemical cell units, electrically connected in series.

Thus, in a second aspect, the present invention accordingly provides a stack of electrochemical cells, wherein each electrochemical cell is according to the first aspect.

The gas transport layer and electrode layer may be deposited sequentially on the metal support by any suitable method.

Thus, in a third aspect, there is provided a method of producing an electrochemical cell, the method comprising: providing a porous metal support, providing a precursor composition comprising at least one precursor for a porous and electrically conductive gas transport layer, applying the precursor composition to the porous substrate, optionally drying, and optionally sintering, thereby forming an electrically conductive gas transport layer having a pore volume fraction of 20% by volume or higher; providing an electrode precursor composition comprising at least one precursor for an electrode layer, and applying the electrode precursor composition on the gas transport layer, optionally drying, and optionally sintering, thereby forming an electrode layer on the gas transport layer, the electrode layer having a pore volume fraction lower than the pore volume fraction of the gas transport layer.

One or more steps of the method may be repeated.

The precursor composition(s) may further comprise a pore former, optionally comprising a material selected from poly(methyl methacrylate) (PMMA), graphite, carbon black, polystyrene and/or mixtures thereof. This is advantageous because it allows control of the pore volume fraction of the gas transport layer.

The precursor or precursors for a porous and electrically conductive gas transport layer may have an average particle size of 200 μm or higher, optionally 250 μm or higher, optionally 300 μm or higher.

The precursor or precursors for a porous and electrically conductive gas transport layer may have an average particle size of 2000 μm or lower, optionally 1800 μm or lower, optionally 1000 μm or lower.

The precursor composition and/or the electrode precursor composition may be applied to the porous substrate by printing, preferably screen-printing.

Optional sintering may be performed at a temperature in the range 750° C. to 1050° C., preferably from 850° C. to 1050° C. Sintering may be performed in an air atmosphere.

In a fourth aspect, there is accordingly provided an electrochemical cell obtainable by a method as claimed in the third aspect.

In a fifth aspect, there is provided the use of an electrochemical cell according to the first aspect as an electrolyser cell or a stack of electrochemical cells according to the second aspect as an electrolyser stack.

In a sixth aspect, there is provided the use of an electrochemical cell according to the first aspect as a fuel cell or a stack of electrochemical cells according to the second aspect as a fuel cell stack.

### DEFINITIONS

In this specification, the terms “lanthanoid”, “lanthanide” and “Ln” are used interchangeably and mean the metallic chemical elements with atomic numbers 57-71.

The term “dopant” as used herein is not intended to be restricted to a maximum percentage of elements, ions or compounds added to chemical structures. Similarly, the term “doping” is intended to mean the addition of a certain amount of elements, ions, or compounds to a material. It is not limited to a maximum quantity of material, after which, further addition of material no longer constitutes doping.

The term “perovskite structure” as used herein refers to a single network of chemically bonded crystal structures which have a generally perovskite (ABX₃) structure. This does not mean that this single network need possess a single, uniform crystal structure throughout the entire structure. However, where different crystal structures occur between different regions of the network, it is often the case that these regions have complementary structures permitting chemical bonds to more easily form therebetween.

The term “solid oxide cell” (SOC) is intended to encompass both solid oxide fuel cells (SOFCs) and solid oxide electrolysis cells (SOECs).

The term “source of” an element, compound or other material refers to a material comprising the element, compound, or other material whether or not chemically bonded in the source. The source of the element, compound or other material may be an elemental source (e.g. Ln, Sm, Gd or O₂) or may be in the form of a compound or mixture comprising the element, compound or other material including one or more of those elements, compounds, or materials.

References to porosity of the gas transport layer refer to pore volume fraction, i.e. the volume of pores in a material to the overall volume of the material and are expressed in percentages.

In this specification, references to electrochemical cell, SOC, SOFC and SOEC may refer to tubular or planar cells. Electrochemical cell units may be tubular or planar in configuration. Planar fuel cell units may be arranged overlying one another in a stack arrangement, for example 100-200 fuel cell units in a stack, with the individual fuel cell units arranged electrically in series. References to “a stack of electrochemical cells” therefore refer to a plurality of electrochemical cells units arranged electrically in series.

Electrochemical cells may be fuel cells, reversible fuel cells or electrolyser cells. Generally, these cells may have the same structure and reference to electrochemical cells may refer (unless the context suggests otherwise) to any of these types of cell.

“Oxidant electrode” or “air electrode” and “fuel electrode” are used herein and may be used interchangeably to refer to cathodes and anodes respectively of SOFCs because of potential confusion between fuel cells or electrolyser/electrolysis cells.

Electrochemical cells as encompassed by the invention may comprise:
a) two planar components welded together with fluid volume in between (e.g. substrate with electrochemical layers and interconnector (separator plate))
b) three planar components welded together with fluid volume in between (e.g. substrate with electrochemical layers and interconnector (separator plate) and spacer providing fluid volume).

The various features of aspects of the disclosure as described herein may be used in combination with any other feature in the same or other aspect of the disclosure, if needed with appropriate modification, as would be understood by the person skilled in the art.

Furthermore, although all aspects of the invention or disclosure preferably “comprise” the features described in relation to that aspect, it is specifically envisaged that they may “consist”or “consist essentially”of those features outlined in the claims.

The invention will now be described with reference to accompanying figures and examples.

### BRIEF DESCRIPTION OF THE FIGURES

FIG. 1 shows a graph of predicted cell overpotential against gas transport layer (GTL) thickness for SOEC mode.

FIG. 2 shows predicted cell overpotential as a function of GTL pore volume fraction and pore diameter.

FIG. 3 shows a graph of predicted cell voltage against current density in fuel cell (positive current) and electrolysis cell (negative current) modes for electrodes with and without a GTL at standard metal support porosity.

FIG. 4 shows a graph of cell voltage against current density in fuel cell (positive current) and electrolysis cell (negative current) modes for electrodes with and without GTL. The ratio of electrode area: hole area in FIG. 4 is 25 times greater than in FIG. 3.

FIG. 5 shows an electron micrograph of a GTL layer of an electrochemical cell.

FIG. 6 shows a graph of cell voltage as a function of normalised current density of a cell at 600° C.; 50%:50% H₂:H₂O according to the disclosure.

FIG. 7 shows an electron micrograph of a GTL layer, electrode layer and part of the electrolyte layer of an electrochemical cell.

FIG. 8 is a schematic cross section of an electrochemical cell

### DETAILED DESCRIPTION OF THE INVENTION

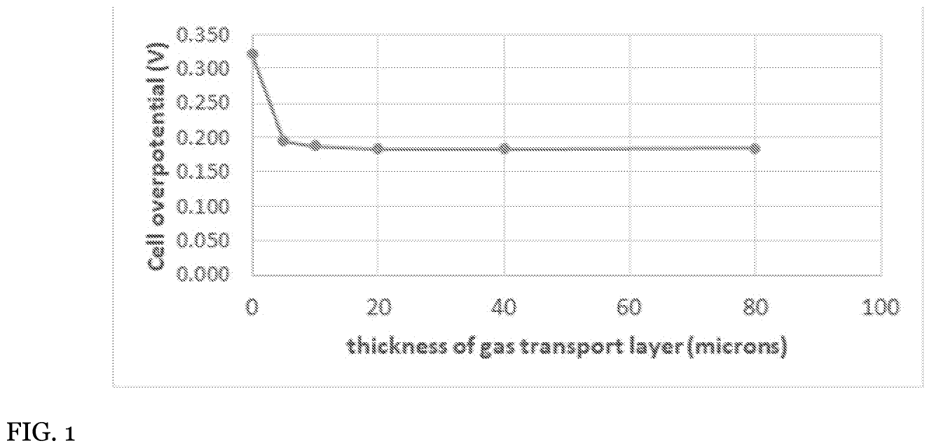

FIG. 1 shows a graph of predicted cell overpotential against gas transport layer thickness for SOEC mode (0.5 A/cm²; 50%/50% H₂/H₂O T=600° C., standard porosity). Pore diameter is 800 nm and pore volume fraction is 32%. The result of this analysis using a gas transport model suggest that at a thickness of >5 or >10 μm the effect of the GTL thickness on cell overpotential is less important.

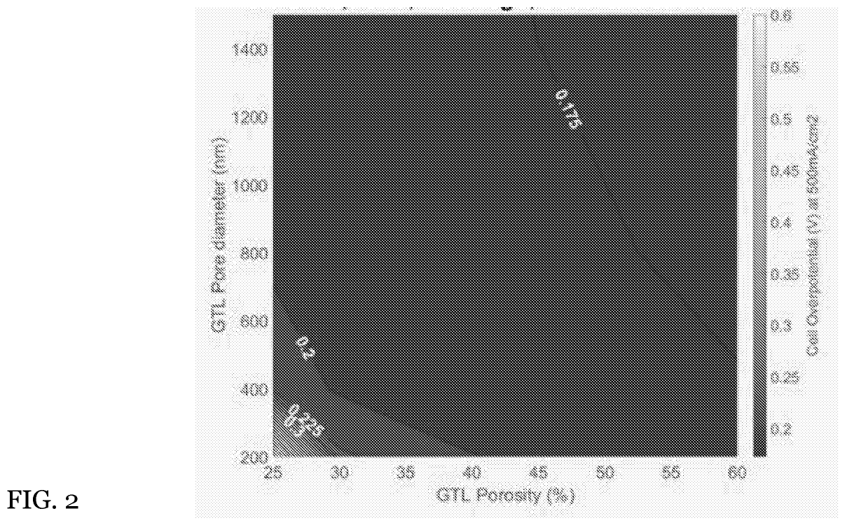

FIG. 2 shows predicted cell overpotential as a function of GTL pore volume fraction (SOEC mode; 0.5 A/cm²; 50%/50% H₂/H₂O T=600° C.). The results and analysis suggest pore volume fraction and pore size improve gas transport. This effect on gas transport appears to taper off above 40% pore volume fraction and 600 nm pore diameter.

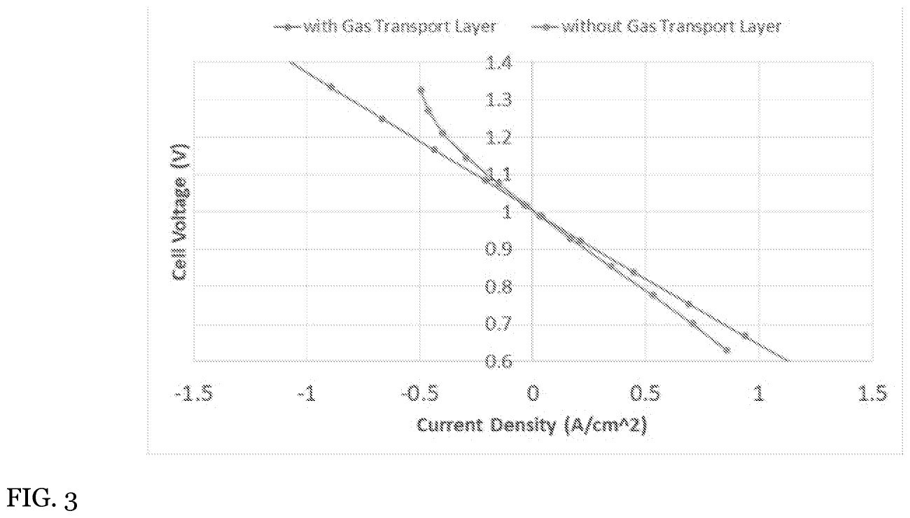

FIG. 3 shows a graph of cell voltage against current density to predict performance in fuel cell (positive current) and electrolysis cell (negative current) modes for electrodes with and without GTL (0.5 A/cm²; 50%/50% H₂/H₂O T=600° C.). Standard metal support porosity is a functional area to hole area ratio of approx. 50-200. The functional area corresponds to the coated area of the metal support that is available for electrochemical activity.

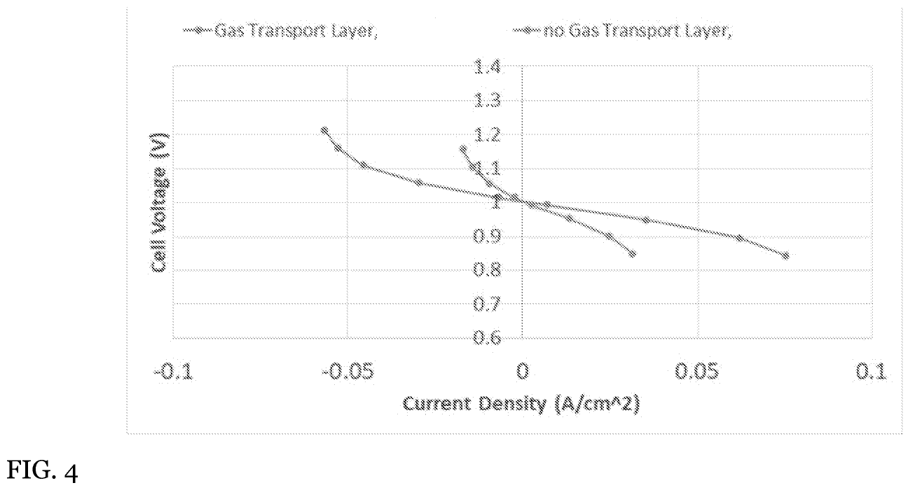

FIG. 4 shows a graph of cell voltage against current density to predict performance in fuel cell (positive current) and electrolysis cell (negative current) modes for electrodes with and without GTL (0.5 A/cm²; 50%/50% H₂/H₂O T=600° C.). A metal support porosity has a ratio of electrode area (also known as functional area) to hole area 25 times that of standard (as in FIG. 3). Thus modelling results show that the GTL allows for a reduction in required porosity of the metal support without loss of activity.

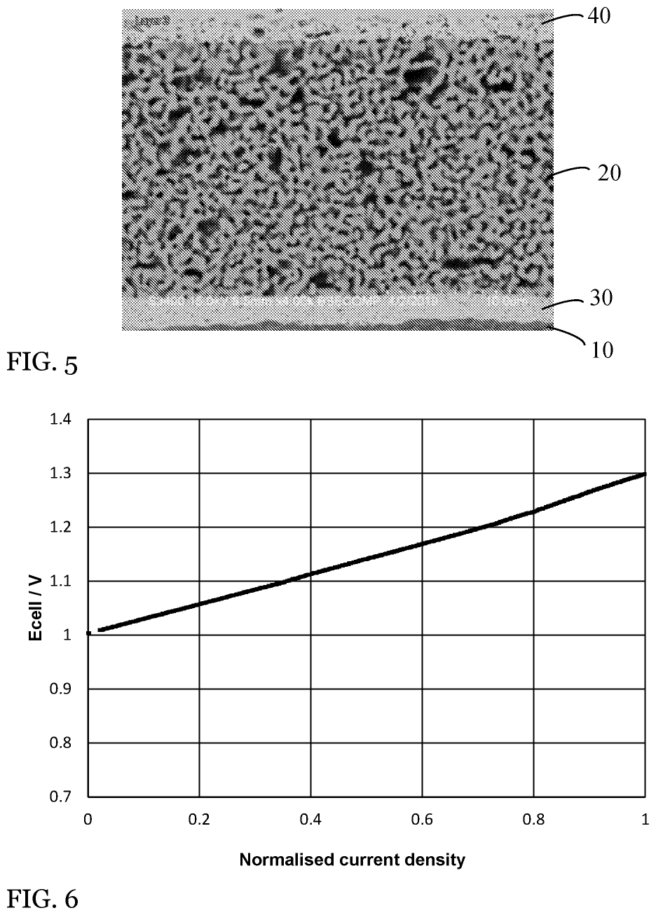

FIG. 5 shows an electron micrograph of a GTL layer of an electrochemical cell in which the GTL 20 of lanthanum strontium chromium manganite (La_{0.75}Sr_{0.25}Cr_{0.5}Mn_{0.5}O₃₋ₓ) is located on a barrier layer 30 on the stainless steel metal support 10. The fuel electrode layer 40 of Ni:CGO is located on the GTL 20.

FIG. 6 shows an I-V curve of a cell at 6000° C. with 50%:50% H₂:H₂O atmosphere according to the disclosure showing that the cell voltage may be up to 1.3 V at a normalised current density of 1.

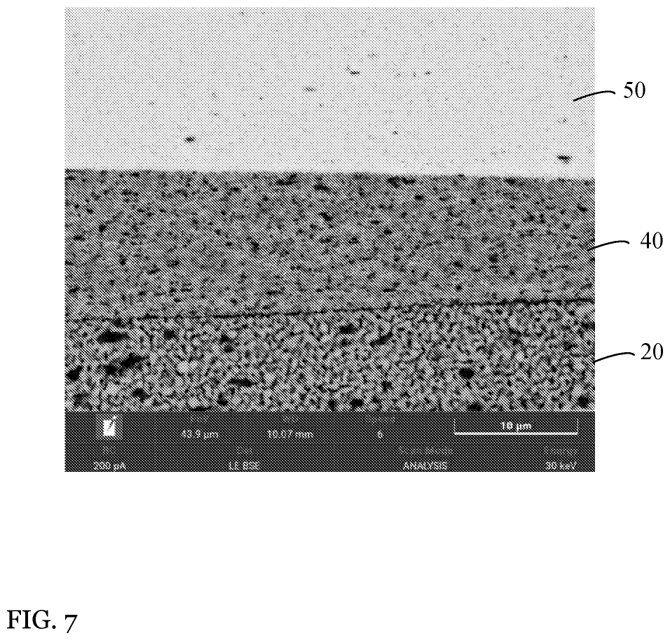

FIG. 7 shows an electron micrograph of a GTL layer, electrode layer and part of the electrolyte layer of an electrochemical cell. The GTL 20 of lanthanum strontium chromium manganite (La_{0.75}Sr_{0.25}Cr_{0.5}Mn_{0.5}O₃₋ₓ) is located on the metal support (not shown). The fuel electrode layer 40 of Ni:CGO is on the GTL 20 and the electrolyte layer 50 of GDC is on the electrode layer.

Other suitable GTL layer materials include LSCrMn (La_{0.75}Sr_{0.25})₁₋ₓCr_{0.5}Mn_{0.5}O_{3-δ}; SrTiO3 (doped with Nb, Y, La, Ni, Ca, Fe, Ce) such as La_{0.2}Sr_{0.8}Ti_{0.9}Ni_{0.1}O₃ or La_{0.3}Sr_{0.6}Ce_{0.1}Ni_{0.1}Ti_{0.9}O₃(LSCNT); Y_{0.8}Ca_{0.2}Cr_{0.8}Co_{0.2}O₃ YCCC-SDC; Sr₂Fe_{1.5}Mo_{0.5}O₆, Sr₂MgMoO₆, double perovskite; PrBaMn₂O₅(PBMO) A-site ordered perovskite; SrFe_{0.2}Co_{0.4}Mo_{0.4}O₃ (SFCM); or PrBaMn₂O₅(PBMO) A-site ordered perovskite.

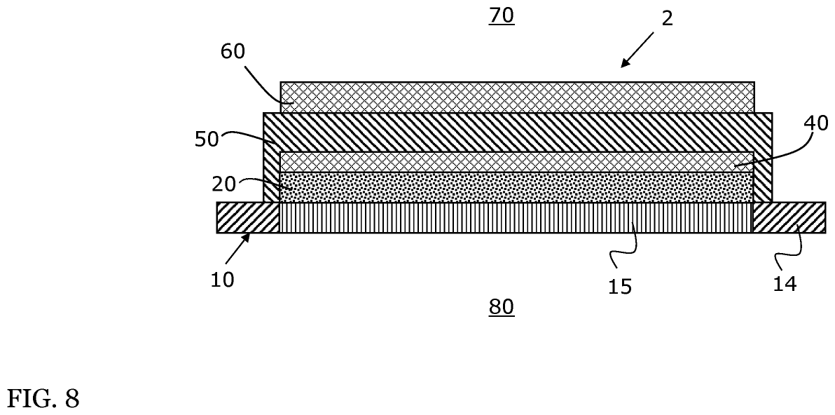

FIG. 8 is a schematic cross section, not to scale, of an electrochemical cell 2 that may be a SOFC or a SOEC. A ferritic stainless steel metal support 10 has a peripheral, non-porous portion 14 and a central, porous portion 15 where holes have been drilled through the metal support 4. The GTL 20 of e.g. lanthanum strontium chromium manganite (La_{0.75}Sr_{0.25}Cr_{0.5}Mn_{0.5}O₃₋ₓ) is located on a barrier layer (not shown) on the ferritic stainless steel metal support 10. The fuel electrode layer 40 of e.g. Ni:CGO is located on the GTL 20 and the electrolyte layer 50 (which may have one or more layers e.g. including a layer of GDC) is located on the fuel electrode layer 40. The electrolyte layer 50 surrounds the GTL 20 and the fuel electrode layer 40 to prevent gas flowing laterally through the GTL 20 or fuel electrode layer 40 from the fuel side 80 to the air (oxidant) side 70 or vice versa. An air electrode layer 60 which may have one or more layers (e.g. a bulk layer of La_{0.99}Co_{0.4}Ni_{0.6}O_{(3-δ)} (LCN60)), is located on the electrolyte layer 50.

The metal support 10 has a number of laser-drilled holes to provide a ratio of electrode area to hole area in this region in the range 20-2500. The ratio involves only the areas in the “active” region of the substrate. It does not include the areas of the substrate outside of the drilled region (e.g. the edges of the substrate). If it is desired to reduce the drilled area in SOFCs, an GTL optimized for diffusion as described herein enables a ratio of 2500 before the resistance of the cell is higher than a standard cell without a GTL.

Methods to determine pore volume fraction include 2D SEM images. In this method, a sample is cross-sectioned and imaged on the SEM at high resolution. Image processing is then used to separate the phases (i.e. GTL material and pores) and calculate a phase fraction. This is a convenient method. Other methods include FIB-SEM tomography in which a focused ion beam (FIB) is used to cut slices of material while scanning electron microscope (SEM) is used to image each slice. Image processing enables 3D reconstruction and determination of volume of pores/phases. This is generally considered a high resolution method.

### Example: Synthesis of a Printable Ink

### Dispersal and Milling of Precursor

The lanthanum strontium chromium manganite (La_{0.75}Sr_{0.25}Cr_{0.5}Mn_{0.5}O₃₋ₓ) GTL shown above, was prepared as follows:

The powder was weighed out and mixed with a carrier, a dispersant, and an anti-foaming agent to form a slurry comprising a target amount of 70 wt % powder.

The slurry was transferred to a basket mill.

The slurry was milled at around 7000 rpm for 4 hours until a d₅₀<0.25 μm and d₉₀<0.8 μm was achieved. The particle size distribution may be measured using a Malvern Mastersizer® 2000 laser diffraction particle size analyser.

The slurry was then removed from the basket mill.

### Ink Manufacture

The dispersed and milled lanthanum strontium chromium manganite powder slurry made in the preceding section was transferred to small high-shear disperser (HSD) pot and placed on the HSD.

Binder powder in an amount corresponding to 1 to 3.5 wt % of finished ink was weighed out.

The binder was added to slurry being actively dispersed on the HSD, until the binder fully dissolves in the ink.

The ink was the transferred to a triple roll mill (TRM) for final homogenisation and passed through the mill four times with a front nip of 5 μm, ensuring the binder is fully homogenised into the ink and that no particles bigger than 5 μm remain in the finished ink.

### Example 2: Printing the Ink and Forming the Active Layer

The substrate in question comprised a coated metal support with laser drilled holes for porosity. The ink was screen printed, using an automated screen printer, as a single pass on to the metal support. It was then dried on the drying belt. The combination of ink solids content and screen mesh was chosen to give a print of approximately 15-20 μm thick. Following addition of an electrode layer and electrolyte layer, it was sintered at a temperature from 900 to 1050° C.

### REFERENCE NUMERALS

2 electrochemical cell
10 metal support
14 non-porous portion of metal support
15 porous portion of metal support
20 gas transport layer (GTL)
30 barrier layer
40 fuel electrode layer
50 electrolyte layer
60 air electrode
70 air (oxidant) side
80 fuel side

All publications mentioned in the above specification are herein incorporated by reference. Although illustrative embodiments of the invention have been disclosed in detail herein, with reference to the accompanying drawings, it is understood that the invention is not limited to the precise embodiment and that various changes and modifications can be performed therein by one skilled in the art without departing from the scope of the invention as defined by the appended claims and their equivalents.

1. An electrochemical cell comprising:
a porous metal support, a gas transport layer on the porous metal support, and an electrode layer on the gas transport layer,
wherein the gas transport layer is electrically conductive and has an open pore structure comprising a pore volume fraction of 20% by volume or higher and wherein the electrode layer has a pore volume fraction lower than the pore volume fraction of the gas transport layer.

2. An electrochemical cell as claimed in claim 1, wherein the gas transport layer comprises an electrically conductive ceramic material.

3. An electrochemical cell as claimed in claim 2, wherein the gas transport layer comprises a perovskite material.

4. An electrochemical cell as claimed in claim 3, wherein the gas transport layer comprises a doped perovskite material, optionally selected from strontium and manganese doped lanthanum chromite, lanthanum strontium chromium manganite (La_{0.75}Sr_{0.25}Cr_{0.5}Mn_{0.5}O₃₋ₓ), doped SrTiO₃, YₓCa₁₋ₓCr_{y}Co_{1-y}O_{3-δ}, Y_{0.8}Ca_{0.2}Cr_{0.8}Co_{0.2}O₃ (YCCC-SDC), Sr₂Fe_{1.5}Mo_{0.5}O₆MgMoO₆, SrFe_{0.2}Co_{0.4}Mo_{0.4}O₃ (SFCM), PrBaMn₂O₅ (PBMO) and/or mixtures thereof.

5. An electrochemical cell as claimed in claim 1, wherein the gas transport layer has a thickness of 5 μm or higher, optionally 7 μm or higher, optionally 10 μm or higher, optionally 15 μm or higher, optionally 20 μm or higher, optionally 25 μm or higher, optionally 30 μm or higher, optionally 35 μm or higher, optionally 40 μm or higher.

6. An electrochemical cell as claimed in claim 1, wherein the gas transport layer has a thickness of 80 μm or lower, optionally 70 μm or lower, optionally 60 μm or lower, optionally 50 μm or lower, optionally 40 μm or lower.

7. An electrochemical cell as claimed in claim 1, wherein the gas transport layer has a pore volume fraction of 22% or higher, optionally 25% or higher, optionally 30% or higher.

8. An electrochemical cell as claimed in claim 1, wherein the gas transport layer has a pore volume fraction of 75% or lower, optionally 70% or lower, optionally 65% or lower.

9. An electrochemical cell as claimed in claim 1, wherein the gas transport layer has an average pore size of 200 nm or higher, optionally 300 nm or higher, optionally 400 nm or higher.

10. An electrochemical cell as claimed in claim 1, wherein the gas transport layer has an average pore size of 1.5 μm or lower, optionally 1.2 μm or lower, optionally 800 nm or lower, optionally 600 nm or lower.

11. An electrochemical cell as claimed in claim 1, wherein the electrode layer comprises a different material to the gas transport layer.

12. An electrochemical cell as claimed in claim 1, wherein the electrode layer comprises doped ceria or doped zirconia, optionally wherein the electrode layer comprises doped ceria gadolinium oxide (CGO) or yttrium stabilised zirconia.

13-14. (canceled)

15. An electrochemical cell as claimed in claim 1, wherein the electrode layer has a thickness of 3 μm or higher, optionally 5 μm or higher, optionally 10 μm or higher, optionally 15 μm or higher.

16. An electrochemical cell as claimed in claim 1, wherein the electrode layer has a thickness of 50 μm or lower, optionally 45 μm or lower, optionally 40 μm or lower, optionally 35 μm or lower.

17. An electrochemical cell as claimed in claim 1, wherein the electrode is a fuel electrode.

18. An electrochemical cell as claimed in claim 1, further comprising an electrolyte layer on the electrode layer, optionally wherein the electrolyte layer comprises doped ceria, optionally selected from samarium-doped ceria (SDC), gadolinium-doped ceria (GDC), praseodymium doped ceria (PDC), samaria gadolinia doped ceria (SGDC) and mixtures thereof.

19. (canceled)

20. An electrochemical cell as claimed in claim 1, wherein the porous metal support comprises steel, preferably stainless steel.

21. (canceled)

22. An electrochemical cell as claimed in claim 1, wherein the ratio of functional area of metal support to the area of pores in the metal support is 20 or higher, optionally 50 or higher, optionally 80 or higher, optionally 100 or higher, optionally 110 or higher, optionally 120 or higher, optionally 130 or higher, optionally 140 or higher, optionally 150 or higher.

23. (canceled)

24. A stack of electrochemical cells, wherein each electrochemical cell is as claimed in claim 1.

25. A method of producing an electrochemical cell, the method comprising
providing a porous metal support,
providing a precursor composition comprising at least one precursor for a porous and electrically conductive gas transport layer,
applying the precursor composition to the porous substrate, optionally drying, and optionally sintering, thereby forming an electrically conductive gas transport layer having a pore volume fraction of 20% by volume or higher;
providing an electrode precursor composition comprising at least one precursor for an electrode layer, and
applying the electrode precursor composition on the gas transport layer, optionally drying, and optionally sintering, thereby forming an electrode layer on the gas transport layer, the electrode layer having a pore volume fraction lower than the pore volume fraction of the gas transport layer.
